(19) United States
(12) Patent Application Publication
(10) Pub. No.: US 2026/0125052 A1
(43) Pub. Date: May 7, 2026

(54) DRIVE SUPPORT SYSTEM AND DRIVE SUPPORT METHOD

(71) Applicants: DENSO CORPORATION, Kariya-city (JP); J-QuAD DYNAMICS Inc., Tokyo (JP)

(72) Inventors: Shogo MATSUNAGA, Tokyo (JP); Tsuyoshi INO, Kariya-city (JP); Noriyasu NOTO, Kariya-city (JP)

(21) Appl. No.: 19/370,283

(22) Filed: Oct. 27, 2025

(30) Foreign Application Priority Data
Nov. 1, 2024 (JP) 2024-193086

(51) Int. Cl. B60W 30/09; B60W 10/18; B60W 10/20; B60W 30/095; B60W 30/14; B60W 50/14

(52) U.S. Cl. CPC B60W 30/09; B60W 10/18; B60W 10/20; B60W 30/0953; B60W 30/0956; B60W 30/143; B60W 50/14; B60W 2554/4042; B60W 2554/4044

(57) ABSTRACT

A drive support system includes: a time prediction unit of an arrival time; a position prediction unit of front end and rear end passing-through positions; a margin distance setting unit of a margin distance; a determination position setting unit of front end and rear end determination positions and front end and rear end crossing positions; and a determination unit for determining that the drive support is not necessary when the front end determination position is located behind the rear end crossing position or the rear end determination position is located ahead of the front end crossing position in a traveling direction of the crossing mobile object and for determining that the drive support is necessary when the front end determination position is located ahead of the rear end crossing position, and the rear end determination position is located behind the front end crossing position.

### CROSS REFERENCE TO RELATED APPLICATION

The present application claims the benefit of priority from Japanese Patent Application No. 2024-193086 filed on Nov. 1, 2024. The entire disclosure of the above application is incorporated herein by reference.

### TECHNICAL FIELD

The present disclosure of this specification relates to a drive support system and a drive support method.

### BACKGROUND ART

JP 2020-8288 A teaches a collision determination device that determines whether a collision occurs between a vehicle and an object based on whether the vehicle body crosses a moving path of the object. The disclosure of JP 2020-8288 A is incorporated herein by reference as an explanation of technical elements in the present disclosure.

### SUMMARY OF INVENTION

According to an example, a drive support system may include: a detection device that detects a surrounding object; a subject vehicle trajectory prediction unit that predicts a subject vehicle trajectory which is a movement trajectory of a subject vehicle; an object trajectory prediction unit that predicts an object trajectory which is a movement trajectory of a crossing mobile object detected by the detection device; a time prediction unit that predicts an arrival time which is a time required for the subject vehicle to arrive at a crossing area where the subject vehicle trajectory and the object trajectory cross each other; a position prediction unit that predicts a front end passing-through position which is a position of a front end of the crossing mobile object at a time when the arrival time has elapsed, and a rear end passing-through position which is a position of a rear end of the crossing mobile object at the time when the arrival time has elapsed; a margin distance setting unit that sets a margin distance required between the subject vehicle and the crossing mobile object at the time when the arrival time has elapsed; a determination position setting unit that sets a front end determination position which is a position calculated by adding the margin distance to the front end passing-through position in a travelling direction of the crossing mobile object, and a rear end determination position which is a position calculated by adding the margin distance to the rear end passing-through position of in a direction opposite to the travelling direction of the crossing mobile object, and that sets a front end crossing position which is an end position located ahead of the crossing mobile object in the travelling direction of the crossing mobile object in an crossing area, and a rear end crossing position which is an end position located behind the crossing mobile object in the travelling direction of the crossing mobile object in the crossing area; a determination unit that determines that a drive support is not necessary when the front end determination position is located behind the rear end crossing position in the traveling direction of the crossing mobile object, or when the rear end determination position is located ahead of the front end crossing position in the traveling direction of the crossing mobile object, and determines that the drive support is necessary when the front end determination position is located ahead of the rear end crossing position in the traveling direction of the crossing mobile object, and the rear end determination position is located behind the front end crossing position in the traveling direction of the crossing mobile object; and a drive support control unit that provides the drive support using a drive support device when the determination unit determines that the drive support is necessary, and stops the drive support when the determination unit determines that the drive support is not necessary.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a configuration of a drive support system;

FIG. 2 is a diagram showing the current positions of a subject vehicle and a crossing mobile object;

FIG. 3 is a diagram showing the positional relationship between the subject vehicle and a crossing mobile object at the time when the arrival time has elapsed;

FIG. 4 is a flowchart relating to crossing drive support control;

FIG. 5 is a flowchart relating to step S130 in FIG. 4;

FIG. 6 is a diagram showing a characteristic map of the relationship between the subject vehicle speed and the additional distance;

FIG. 7 is an explanatory diagram for explaining a front end determination position and a rear end determination position;

FIG. 8 is a diagram showing a case where the front end determination position is located behind the crossing area;

FIG. 9 is a diagram showing a case where the front end determination position is located in the crossing area;

FIG. 10 is a diagram showing a case where a crossing mobile object is located within the crossing area at the time when the arrival time has elapsed;

FIG. 11 is a diagram showing a case where the rear end determination position is located in the crossing area;

FIG. 12 is a diagram showing a case where the rear end determination position is located ahead of the crossing area;

FIG. 13 is a flow chart showing a crossing support control in a second embodiment;

FIG. 14 is a flowchart relating to step S230 in FIG. 13;

FIG. 15 is a diagram showing a case where the front end determination position is located in the crossing area; and

FIG. 16 is a diagram showing the positional relationship between the current position of the crossing mobile object and a position of the crossing mobile object at the time when the arrival time has elapsed.

### DETAILED DESCRIPTION

In the configuration of JP 2020-8288 A, a collision between the vehicle and an object is determined, and control is executed to reduce the vehicle speed as collision restriction control as necessary. However, it does not anticipate drive support in a crossing situation without collision. Even in a crossing situation where no collision occurs, if two vehicles cross each other at a close range, an occupant of the other vehicle may be scared of a possibility of a collision, or the driver of the subject vehicle may feel fear of a possibility of a collision. For this reason, there is a requirement for a drive support system that can avoid crossing each other at a close range and improve safety in a crossing situation. In the above-described viewpoints or in other viewpoints not described, further improvements are required in the drive support system.

One object of the embodiments is to provide a drive support system that can improve safety in a crossing situation.

The drive support system according to the embodiments herein includes: a detection device that detects a surrounding object; a subject vehicle trajectory prediction unit that predicts a subject vehicle trajectory which is a movement trajectory of a subject vehicle; an object trajectory prediction unit that predicts an object trajectory which is a movement trajectory of a crossing mobile object detected by the detection device; a time prediction unit that predicts an arrival time, which is a time required for the subject vehicle to arrive at a crossing area where the subject vehicle trajectory and the object trajectory cross each other; a position prediction unit that predicts a front end passing-through position which is a position of a front end of the crossing mobile object at a time when the arrival time has elapsed, and a rear end passing-through position which is a position of a rear end of the crossing mobile object at the time when the arrival time has elapsed; a margin distance setting unit that sets a margin distance required between the subject vehicle and the crossing mobile object at the time when the arrival time has elapsed; a determination position setting unit that sets a front end determination position that is a position which is calculated by adding a margin distance to the front end passing-through position in a travelling direction of the crossing mobile object, and a rear end determination position that is a position which is calculated by adding a margin distance to the rear end passing-through position in a direction opposite to the travelling direction of the crossing mobile object, and that sets a front end crossing position that is an end position located ahead of the crossing mobile object in the travelling direction of the crossing mobile object in an crossing area, and a rear end crossing position that is an end position located behind the crossing mobile object in the travelling direction of the crossing mobile object in the crossing area; a determination unit that determines that a drive support is not necessary when the front end determination position is located behind the rear end crossing position in the traveling direction of the crossing mobile object, or when the rear end determination position is located ahead of the front end crossing position in the traveling direction of the crossing mobile object, and determines that the drive support is necessary when the front end determination position is located ahead of the rear end crossing position in the traveling direction of the crossing mobile object, and the rear end determination position is located behind the front end crossing position in the traveling direction of the crossing mobile object; and a drive support control unit that provides the drive support using a drive support device when the determination unit determines that the drive support is necessary, and stops the drive support when the determination unit determines that the drive support is not necessary.

The drive support system according to the embodiments includes a determination unit that determines that a drive support is not necessary when the front end determination position is located behind the rear end crossing position in the traveling direction of the crossing mobile object, or when the rear end determination position is located ahead of the front end crossing position in the traveling direction of the crossing mobile object, and determines that the drive support is necessary when the front end determination position is located ahead of the rear end crossing position in the traveling direction of the crossing mobile object, and the rear end determination position is located behind the front end crossing position in the traveling direction of the crossing mobile object; and Therefore, the drive support can be provided in a crossing situation at a close distance where a crossing area is disposed between the front end determination position and the rear end determination position. Therefore, it is easy to ensure a sufficient distance between the subject vehicle and the crossing mobile object, thereby improving safety in the crossing situation. Thus, the embodiments provides a drive support system that can improve safety in a crossing situation.

The disclosed aspects in this specification adopt different technical solutions from each other in order to achieve their respective objectives. Reference numerals in parentheses described in the features and this section exemplarily show corresponding relationships with parts of embodiments to be described later and are not intended to limit technical scopes. The objects, features, and advantages disclosed in this specification will become apparent by referring to following detailed descriptions and accompanying drawings.

Multiple embodiments will be described with reference to the drawings. In some embodiments, functionally and/or structurally corresponding and/or associated parts may be given the same reference numerals, or reference numerals with different digit placed on equal to or higher than a hundred place. For corresponding parts and/or associated parts, additional explanations can be made to the description of other embodiments.

### First Embodiment

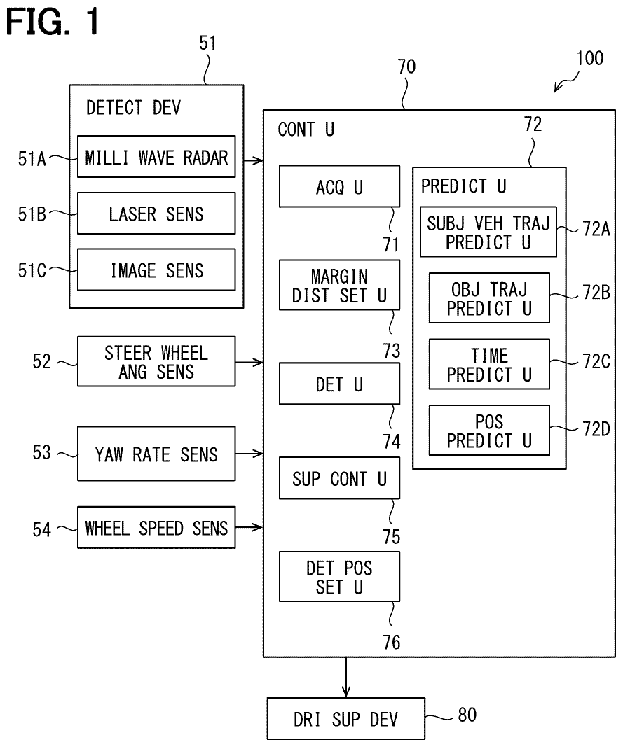

In FIG. 1, a drive support system 100 is a system that support a drive operation in accordance with the situation of the subject vehicle and its surrounding situation. As the drive support, it is possible to employ drive support that changes the vehicle behavior, such as braking support or steering support. Further, as the drive support, it is possible to employ the drive support that alerts the driver, such as collision warning support that alerts the driver when there is a possibility of collision with a surrounding object.

The drive support system 100 includes a detection device 51, a steering angle sensor 52, a yaw rate sensor 53, and a wheel speed sensor 54. The steering angle sensor 52 is attached to the steering rod of the subject vehicle. The steering angle sensor 52 outputs a steering angle signal corresponding to a change in the steering angle of the steering wheel in accordance with the driver's operation. The yaw rate sensor 53 is provided at the center of the subject vehicle and outputs a yaw rate signal corresponding to the rate of change in the steering amount of the subject vehicle. The wheel speed sensor 54 is attached to the wheel of the subject vehicle. The wheel speed sensor 54 outputs a wheel speed signal corresponding to the wheel speed of the subject vehicle.

The detection device 51 is a sensor for detecting a surrounding object. The object as a detection target includes a moving object or an object that may move. More specifically, the object as the detection target includes a vehicle, a motorcycle, a bicycle, a pedestrian, an animal, and the like. In addition, although it is not an object as a target of the crossing drive support control described below, a stationary object such as a parked vehicle and a guardrail can also be detected.

The detection device 51 includes a millimeter wave radar 51A, a laser sensor 51B, and an image sensor 51C. The millimeter wave radar 51A transmits a millimeter wave and receives a reflection wave generated when the transmitted millimeter wave is reflected by an object. The laser sensor 51B transmits a laser beam having a shorter wavelength than the millimeter wave transmitted by the millimeter wave radar 51A, and receives a reflection wave generated when the transmitted laser beam is reflected by an object. The millimeter wave radar 51A and the laser sensor 51B detect the position of an object around the subject vehicle and the relative speed of the object with respect to the subject vehicle based on the respective reflection waves. The image sensor 51C detects the position of an object and the relative speed of the object with respect to the subject vehicle using an image captured by the imaging device. The detection device 51 may be configured to acquire information about a surrounding vehicle using vehicle-to-vehicle communication.

Of the objects detected by the detection device 51, an object that is expected to cross the road in the traveling direction of the subject vehicle is detected as a crossing mobile object 20. The crossing mobile object 20 can be said to be an object that moves so as to cross with the subject vehicle. The crossing mobile object 20 is assumed to be another vehicle traveling through the intersection in a direction that crosses the traveling direction of the subject vehicle. More specifically, another vehicle may be expected to travel straight on the crossing road when the subject vehicle travels straight through an intersection, or another vehicle may be expected to travel straight in the oncoming lane when the subject vehicle turns right or left. The crossing mobile object 20 may be a pedestrian or an animal crossing the road on which the subject vehicle is traveling or a road after the subject vehicle has turned right or left.

The drive support system 100 includes a drive support device 80. The drive support device 80 is a device that supports in a driving operation of the subject vehicle. The drive support device 80 includes a brake support device that executes brake support and a steering support device that executes steering support. Furthermore, the drive support device 80 is equipped with a collision warning device that detects the presence of an object around the subject vehicle and issues a warning if there is a possibility of a collision.

The drive support system 100 includes a control unit 70. The control unit 70 includes an acquisition unit 71, a prediction unit 72, a margin distance setting unit 73, a determination position setting unit 76, a determination unit 74, and a drive support control unit 75. The acquisition unit 71 acquires vehicle information and object information from a sensor mounted on the subject vehicle. The subject vehicle information is information relating to the behavior of the subject vehicle, such as the speed and direction of travel of the subject vehicle. The object information is information about the object, such as the position, size, speed, and direction of travel of the object.

The prediction unit 72 predicts the traffic condition around the subject vehicle, including the behavior of the subject vehicle, based on the subject vehicle information and the object information. The prediction unit 72 includes a subject vehicle trajectory prediction unit 72A, an object trajectory prediction unit 72B, a time prediction unit 72C, and a position prediction unit 72D.

The subject vehicle trajectory prediction unit 72A predicts a subject vehicle trajectory K1 which is a movement trajectory of the subject vehicle. The subject vehicle trajectory prediction unit 72A predicts the subject vehicle trajectory K1 based on the current position, current speed, acceleration, and yaw rate of the subject vehicle. Here, the information used to predict the subject vehicle trajectory K1 is not limited to the above example, and map information from a navigation system, past driving data, and the like may also be used.

The object trajectory prediction unit 72B predicts an object trajectory K2, which is the movement trajectory of the object. The object trajectory K2 also includes the movement trajectory of the object from a past position to the current position of the object. The object trajectory prediction unit 72B predicts the object trajectory K2 based on the current position, current speed, and acceleration of the object. Here, the information used to predict the object trajectory K2 is not limited to the above example, and the shape of the surrounding road, the state of the surrounding objects, and the like may also be used.

The time prediction unit 72C predicts an arrival time, which is the time it takes for the subject vehicle to reach a crossing area CA where the subject vehicle trajectory K1 and the object trajectory K2 cross each other. The crossing area CA will be described below with reference to the drawings.

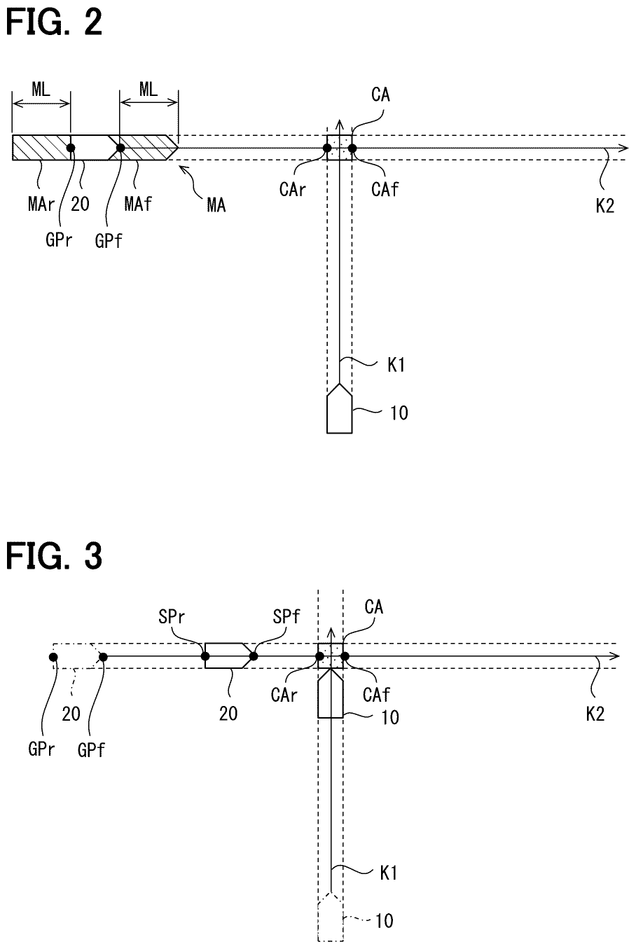

In FIG. 2, the front end position of the crossing movable object 20 at the current time is defined as the current front end position GPf. The rear end position of the crossing movable object 20 at the current time is defined as the current rear end position GPr. The current front end position GPf and the current rear end position GPr are determined by the traveling direction of the crossing movable object 20. That is, the current rear end position GPr is always located behind the current front end position GPf in the traveling direction of the crossing movable object 20.

The subject vehicle trajectory K1, which is the predicted movement trajectory of the subject vehicle 10, and the object trajectory K2, which is the predicted movement trajectory of the crossing mobile object 20, cross each other. The rectangular area around a center of the crossing point is defined as the crossing area CA. If the subject vehicle 10 and the crossing mobile object 20 are present in the crossing area CA at the same time, the subject vehicle 10 and the crossing mobile object 20 will collide. In the drawing, the crossing area CA is hatched with dots.

The length of one side of the rectangular crossing area CA is the width of the subject vehicle 10 in the vehicle width direction, and the length of the other side is the width of the crossing mobile object 20 in the width direction of the crossing mobile object 20. If the crossing mobile object 20 is a vehicle, the width in the width direction of the crossing mobile object is the same as the vehicle width of the crossing mobile object 20.

In the crossing area CA, the end portion located ahead of the crossing mobile object 20 in the traveling direction is the front end crossing position CAf. The front end crossing position CAf can also be said to be the position where the crossing movable object 20 finally exits the crossing area CA. The front end crossing position CAf can also be said to be the point located furthest ahead of the crossing mobile object 20 in the traveling direction of the crossing mobile object 20 among the points where the crossing area CA and the object trajectory K2 cross each other.

In the crossing area CA, the end portion located behind the crossing mobile object 20 in the traveling direction is the rear end crossing position CAr. The rear end crossing position CAr can also be said to be the position where the crossing mobile object 20 first enters the crossing area CA. The rear end crossing position CAr can also be said to be the rearmost point in the traveling direction of the crossing mobile object 20 among the points where the crossing area CA and the object trajectory K2 intersect.

Assume a one-dimensional coordinate system extending in the object trajectory K2, with the crossing situation between the subject vehicle trajectory K1 and the object trajectory K2 as the origin. Here, the area on the traveling direction side of the crossing mobile object 20 with respect to the origin is defined as a positive area, and the area on the opposite side of the traveling direction of the crossing mobile object 20 with respect to the origin is defined as a negative area. In this case, the front end crossing position CAf is a position displaced in the positive direction from the origin by a half of the length of the vehicle width of the subject vehicle 10. On the other hand, the rear end crossing position CAr is a position displaced in the negative direction by a half of the length of the vehicle width of the subject vehicle 10 from the origin. Here, the method for setting the coordinate system is not limited to the above example. Hereinafter, the traveling direction of the crossing mobile object 20 may be referred to as the positive direction, and the direction opposite to the traveling direction of the crossing mobile object 20 may be referred to as the negative direction.

The margin distance setting unit 73 sets a margin area MA and a margin distance ML for the crossing mobile object 20. The margin area MA is the shaded area in the drawing. The margin area MA includes a pre-pass margin area MAf and a post-pass margin area MAr. The margin area MA and the margin distance ML will be described in detail later.

In FIG. 1, the time prediction unit 72C predicts the arrival time based on information on the distance from the current position of the subject vehicle 10 to the crossing area CA and the subject vehicle speed, which is the speed of the subject vehicle 10. Here, the arrival time is the time that is predicted to be required for the subject vehicle 10 to reach the crossing area CA. If even a part of the subject vehicle 10 reaches the crossing area CA, the time elapsed up to the moment of arrival is predicted as the arrival time. The information used to predict the arrival time is not limited to the above example, and information on the acceleration of the subject vehicle 10 may also be used.

The position prediction unit 72D predicts the passing-through position, which is the position of the crossing mobile object 20 at the time when the arrival time has elapsed. The passing-through position includes two positions, which are a front end passing-through position SPf and a rear end passing-through position SPr. The front end passing-through position SPf is the position of the front end of the crossing mobile object 20 at the time when the arrival time has elapsed. The rear end passing-through position SPr is the position of the rear end of the crossing mobile object 20 at the time when the arrival time has elapsed. The passing-through position will be explained below with reference to the drawings.

In FIG. 3, the subject vehicle 10 and the crossing mobile object 20 at the current time are indicated by a dashed line, and the subject vehicle 10 and the crossing mobile object 20 at the time when the arrival time has elapsed are indicated by a solid line. At the time point when the arrival time has elapsed, the front end of the subject vehicle 10 has reached the crossing area CA. The front end position of the crossing mobile object 20 at the time when the arrival time has elapsed is the front end passing-through position SPf. The rear end position of the crossing mobile object 20 at the time when the arrival time has elapsed is the rear end passing-through position SPr. The distance from the front end passing-through position SPf to the rear end passing-through position SPr is equal to the length of the crossing mobile object 20 in the front-rear direction of the crossing mobile object 20. The front end passing-through position SPf, the rear end passing-through position SPr, the front end crossing position CAf, and the rear end crossing position CAr are located on the same straight line in the object trajectory K2.

The position prediction unit 72D predicts the passing-through position based on the arrival time, the current position of the crossing mobile object 20, and the speed of the crossing mobile object 20. Here, the information used to predict the passing-through position is not limited to the above example, and information on the acceleration of the crossing mobile object 20 may also be used in addition.

In FIG. 1, a margin distance setting unit 73 sets a margin distance ML required between the subject vehicle 10 and the crossing mobile object 20 at the time when the arrival time has elapsed. The margin distance ML is a distance that allows the driver of the subject vehicle 10 to pass through the crossing situation between the subject vehicle 10 and the crossing mobile object 20 without feeling excessive fear. The margin distance ML can also be said to be the distance at which the subject vehicle 10 can pass through the crossing mobile object 20 without causing excessive fear to the crossing mobile object 20 at the crossing situation between the subject vehicle 10 and the crossing mobile object 20. The margin distance ML can also be said to be a distance indicating the lateral position margin at the crossing situation between the subject vehicle 10 and the crossing mobile object 20. The method for setting the margin distance ML will be described in detail later.

The determination position setting unit 76 sets a front end crossing position CAf, a rear end crossing position CAr, a front end determination position HPf, and a rear end determination position HPr. The front end determination position HPf and the rear end determination position HPr are positions that serve as references when determining whether or not the drive support is required. The front end determination position HPf and the rear end determination position HPr will be described in detail later.

The determination unit 74 determines whether the drive support is necessary relating to the crossing situation between the subject vehicle 10 and the crossing mobile object 20. The determination unit 74 determines that the drive support is not necessary when the subject vehicle 10 and the crossing mobile object 20 can cross safely with sufficient margin. On the other hand, if the subject vehicle 10 and the crossing mobile object 20 cannot cross safely with sufficient margin, the determination unit 74 determines that the drive support is necessary. A specific example of the determination made by the determination unit 74 will be described later.

The drive support control unit 75 executes the drive support using the drive support device 80 as necessary. When the determination unit 74 determines that the drive support is necessary, the drive support control unit 75 executes the drive support relating to the crossing situation between the subject vehicle 10 and the crossing mobile object 20. On the other hand, when the determination unit 74 determines that the drive support is not necessary, the drive support control unit 75 stops the drive support relating to the crossing situation between the subject vehicle 10 and the crossing mobile object 20.

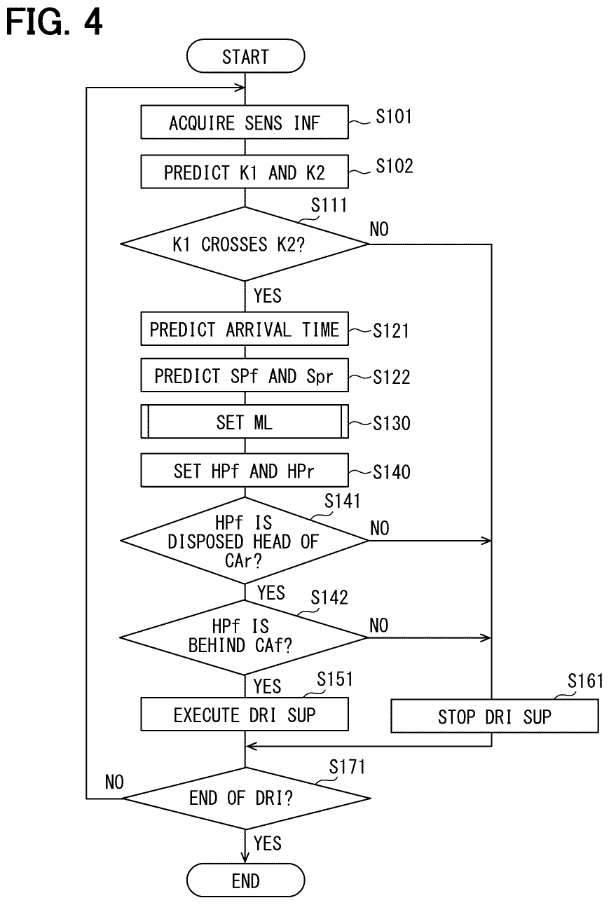

The crossing situation drive support control will be described in detail below. In FIG. 4, when the subject vehicle 10 starts traveling and the crossing situation drive support control is started, the acquisition unit 71 acquires sensor information in step S101. As the sensor information, necessary information such as the vehicle information required to predict the subject vehicle trajectory K1 and the object information required to predict the object trajectory K2 is acquired. After acquiring the sensor information, the process proceeds to step S102.

In step S102, the subject vehicle trajectory prediction unit 72A predicts the subject vehicle trajectory K1 until a predetermined time has elapsed. Furthermore, the object trajectory prediction unit 72B predicts the object trajectory K2 until a predetermined time has elapsed. The object trajectory prediction unit 72B predicts the object trajectory K2 for each detected object. For example, when a vehicle and a pedestrian are detected as objects, the object trajectory K2 of the vehicle and the object trajectory K2 of the pedestrian are predicted, respectively. After the object trajectory K2 is predicted, the process proceeds to step S111.

In step S111, the determination unit 74 determines whether the subject vehicle trajectory K1 and the object trajectory K2 cross each other. If it is determined that the subject vehicle trajectory K1 and the object trajectory K2 cross each other, the process proceeds to step S121. On the other hand, if it is determined that the subject vehicle trajectory K1 and the object trajectory K2 do not cross each other, the process proceeds to step S161. Here, in a situation where there are a plurality of object trajectories K2, if there is at least one object trajectory K2 that crosses the subject vehicle trajectory K1, the process proceeds to step S121. On the other hand, if there is no object trajectory K2 that crosses the subject vehicle trajectory K1, the process proceeds to step S161. Furthermore, when there are no objects around the subject vehicle and no predicted object trajectory K2 exists, this feature corresponds to a case where there is no object trajectory K2 crossing with the subject vehicle trajectory K1. Therefore, even if there is no object around the subject vehicle, the process proceeds to step S161.

In step S121, the time prediction unit 72C predicts the arrival time. When there are a plurality of object trajectories K2 that crosses the subject vehicle trajectory K1, there will be a plurality of crossing areas CA. In this case, the arrival times to the multiple crossing areas CA are predicted. After the arrival time is predicted, the process proceeds to step S122.

In step S122, the position prediction unit 72D predicts the passing-through position. The passing-through positions to be predicted are the front end passing-through position SPf and the rear end passing-through position SPr. When there are a plurality of object trajectories K2 that cross the subject vehicle trajectory K1, the passing-through position for each object trajectory K2 is predicted. After predicting the passing-through position, the process proceeds to step S130.

In step S130, the margin distance setting unit 73 sets the margin distance ML. The margin distance setting unit 73 sets the margin distance ML based on the subject vehicle speed, the object speed, and the like. The margin distance setting process will be described below with reference to the drawings.

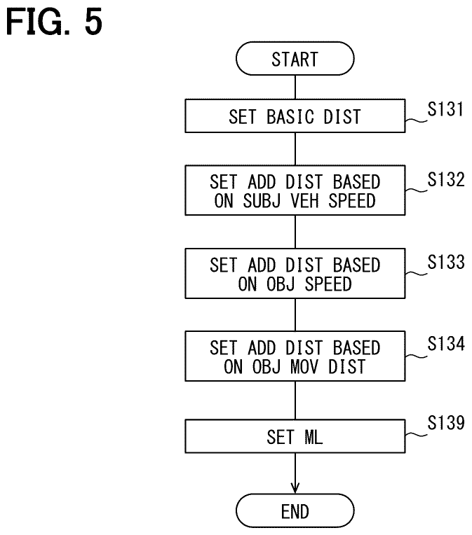

In FIG. 5, when the margin distance setting process is started, the margin distance setting unit 73 sets the basic distance as the margin distance ML in step S131. Here, the basic distance is the minimum value allowed as the margin distance ML, and is a preliminarily determined distance. After the margin distance ML is set to the basic distance, the process proceeds to step S132.

In step S132, the margin distance setting unit 73 sets an additional distance based on the subject vehicle speed. Here, the additional distance refers to a distance that should be added to the basic distance when setting the margin distance ML. The margin distance ML is the sum of the basic distance and the additional distance. If the basic distance is set to zero, the additional distance becomes the margin distance ML as is.

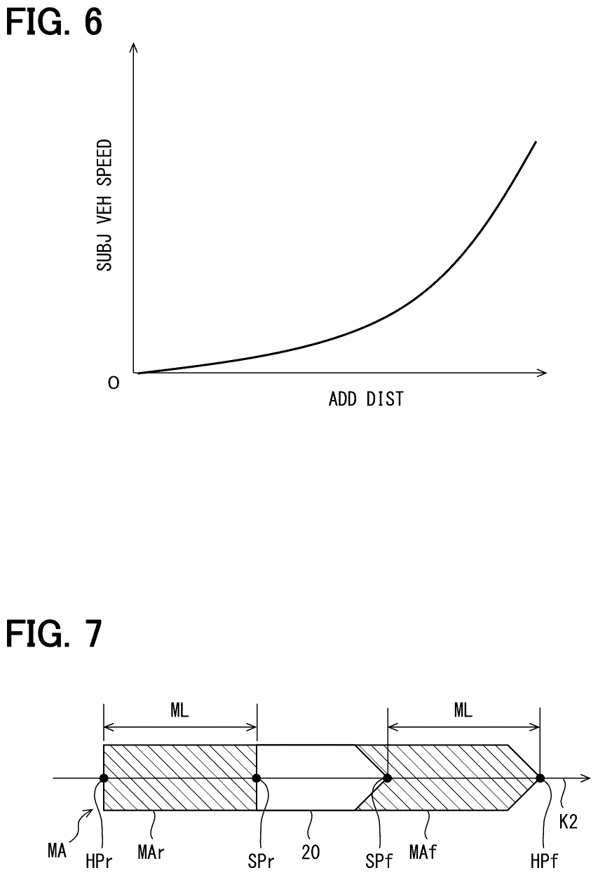

In FIG. 6, the horizontal axis indicates the additional distance, and the vertical axis indicates the subject vehicle speed. As shown in the drawing, the higher the subject vehicle speed, the larger the additional distance is set. This is because the higher the subject vehicle speed, the lower the prediction accuracy tends to be, so it may be better to secure a large additional distance. Furthermore, even if the distance to the crossing mobile object 20 when the subject vehicle 10 and the crossing mobile object 20 cross each other is the same, the faster the subject vehicle speed, the more likely the driver is to feel fear when crossing. This is also one of the reasons why the additional distance is set to a larger value as the subject vehicle speed increases. The additional distance based on the subject vehicle speed is similar to the relationship between the subject vehicle speed and the lateral distance required when the subject vehicle passes by a stationary object. After setting the additional distance based on the subject vehicle speed, the process proceeds to step S133.

In step S133 of FIG. 5, the margin distance setting unit 73 sets an additional distance based on the object speed. The higher the object speed of the crossing mobile object 20, the higher the value set as the additional distance. This is because the higher the object speed, the lower the prediction accuracy tends to be, so it may be better to secure a large additional distance. Furthermore, even if the distance to the crossing mobile object 20 when the subject vehicle 10 and the crossing mobile object 20 cross each other is the same, the higher the object speed, the more likely the driver is to feel fear when crossing. This is also one of the reasons why the additional distance is set to a larger value as the object velocity increases. After setting the additional distance based on the object speed, the process proceeds to step S134.

In step S134, the margin distance setting unit 73 sets an additional distance based on the object movement distance. The object movement distance is the movement distance from the current position of the crossing mobile object 20 to the position of the crossing mobile object 20 at the time when the arrival time has elapsed. The higher the object movement distance, the higher the value set as the additional distance. This is because the larger the object movement distance, the larger the prediction error relating to the crossing mobile object 20 becomes, so it may be better to secure a large additional distance. After setting the additional distance based on the object movement distance, the process proceeds to step S139.

In step S139, the margin distance setting unit 73 sets the margin distance ML. The margin distance setting unit 73 sets the final additional distance by adding together the additional distance based on the subject vehicle speed, the additional distance based on the object speed, and the additional distance based on the object movement distance. The distance acquired by adding this final additional distance and the basic distance is set as the margin distance ML.

In FIG. 7, a margin area MA and a margin distance ML are set for the crossing mobile object 20. The margin areas MA are set ahead of and behind the crossing mobile object 20 along the object trajectory K2. The margin area MA set ahead of the crossing mobile object 20 is a pre-passing-through margin area MAf. The pre-passing-through margin area MAf is an area that extends ahead of the front end of the crossing mobile object 20 along the object trajectory K2 by the length of the margin distance ML. The length of the pre-passing-through margin area MAf along the object trajectory K2 is equal to the length of the margin distance ML.

The margin area MA set behind the crossing mobile object 20 is the post-passing-through margin area MAr. The post-passing-through margin area MAr is an area that extends behind the rear end of the crossing mobile object 20 along the object trajectory K2 by the length of the margin distance ML. The length of the post-passing-through margin area MAr along the object trajectory K2 is equal to the length of the margin distance ML. After the margin distance ML is set, the margin distance setting process ends and the process proceeds to step S140.

In step S140 of FIG. 4, the determination position setting unit 76 sets the front end determination position HPf and the rear end determination position HPr. The front end determination position HPf is a position acquired by adding the margin distance ML in the positive direction to the front end passing-through position SPf. In other words, the front end determination position HPf is a position displaced ahead of the front end passing-through position SPf as a starting point by the margin distance ML along the object trajectory K2. The front end determination position HPf is a position that is equal to the front end of the pre-passing-through margin area MAf.

The rear end determination position HPr is a position acquired by adding a margin distance ML in the negative direction to the rear end passing-through position SPr. In other words, the rear end determination position HPr is a position displaced behind the rear end passing-through position SPr as a starting point by the margin distance ML along the object trajectory K2. The rear end determination position HPr is a position that is equal to the rear end of the post-passing-through margin area MAr. After the front end determination position HPf and the rear end determination position HPr are set, the process proceeds to step S141.

In step S141, the determination unit 74 determines whether the front end determination position HPf is located ahead of the rear end crossing position CAr in the traveling direction of the crossing mobile object 20. If the front end determination position HPf is located ahead of the rear end crossing position CAr, it is determined that there is a possibility that a sufficient distance cannot be secured for crossing the crossing mobile object 20, and the process proceeds to step S142. On the other hand, if the front end determination position HPf is located behind the rear end crossing position CAr, it is determined that a sufficient distance is secured for crossing the crossing mobile object 20, and the process proceeds to step S161.

In step S142, the determination unit 74 determines whether the rear end determination position HPr is located behind the front end crossing position CAf in the traveling direction of the crossing mobile object 20. If the rear end determination position HPr is located behind the front end crossing position CAf, it is determined that there is a possibility that a sufficient distance cannot be secured for crossing the crossing mobile object 20, and the process proceeds to step S151. On the other hand, if the rear end determination position HPr is located ahead of the front end crossing position CAf, it is determined that a sufficient distance is secured for crossing the crossing mobile object 20, and the process proceeds to step S161.

If there are a plurality of crossing mobile objects 20, the determinations in steps S141 and S142 are executed for each of the crossing mobile objects 20. Therefore, if there is at least one crossing mobile object 20 whose front end determination position HPf is located ahead of the rear end crossing position CAr and whose rear end determination position HPr is located behind the front end crossing position CAf, the process will proceed to step S151. On the other hand, if there is no crossing mobile object 20 whose front end determination position HPf is located ahead of the rear end crossing position CAr and whose rear end determination position HPr is located behind the front end crossing position CAf, the process proceeds to step S161.

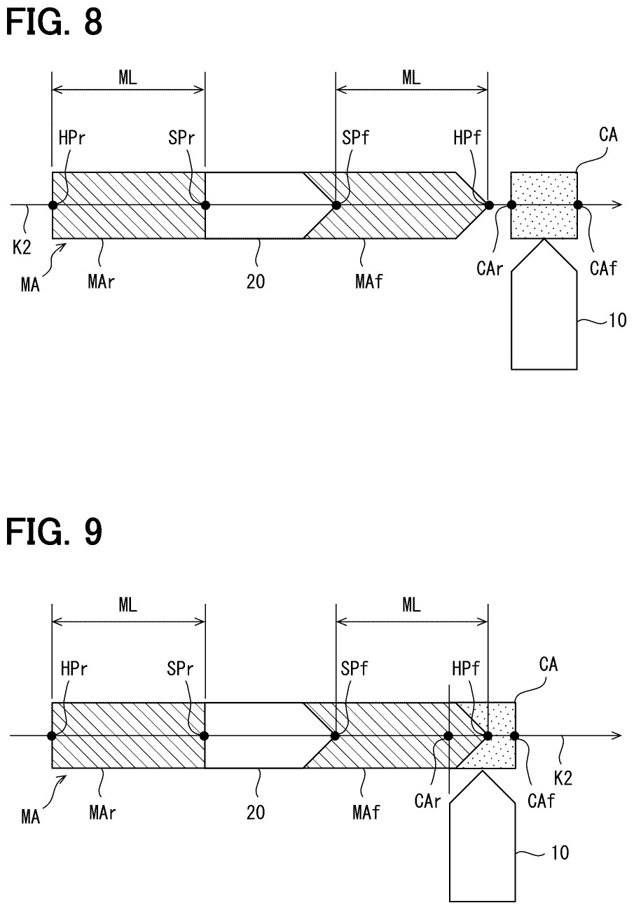

In FIG. 8, the front end crossing position CAf, the rear end crossing position CAr, the front end determination position HPf, and the rear end determination position HPr are located on the same line along the object trajectory K2. In this drawing, the front end determination position HPf is located behind the rear end crossing position CAr. In other words, both the front end determination position HPf and the rear end determination position HPr are located outside the crossing area CA. In other words, neither the pre-passing-through margin area MAf nor the post-passing-through margin area MAr overlaps with the crossing area CA. This state can be said to be a state in which a sufficient distance is secured at the crossing situation where the subject vehicle 10 passes ahead of the crossing mobile object 20.

In FIG. 9, the front end determination position HPf is located ahead of the rear end crossing position CAr, and the rear end determination position HPr is located behind the front end crossing position CAf. More specifically, the front end determination position HPf is located within the crossing area CA. In other words, a part of the pre-passing-through margin area MAf overlaps with the crossing area CA. In this state, there is a possibility that the subject vehicle 10 will pass ahead of the crossing mobile object 20 at close range and cross, and it can be said that there is not sufficient distance for the crossing.

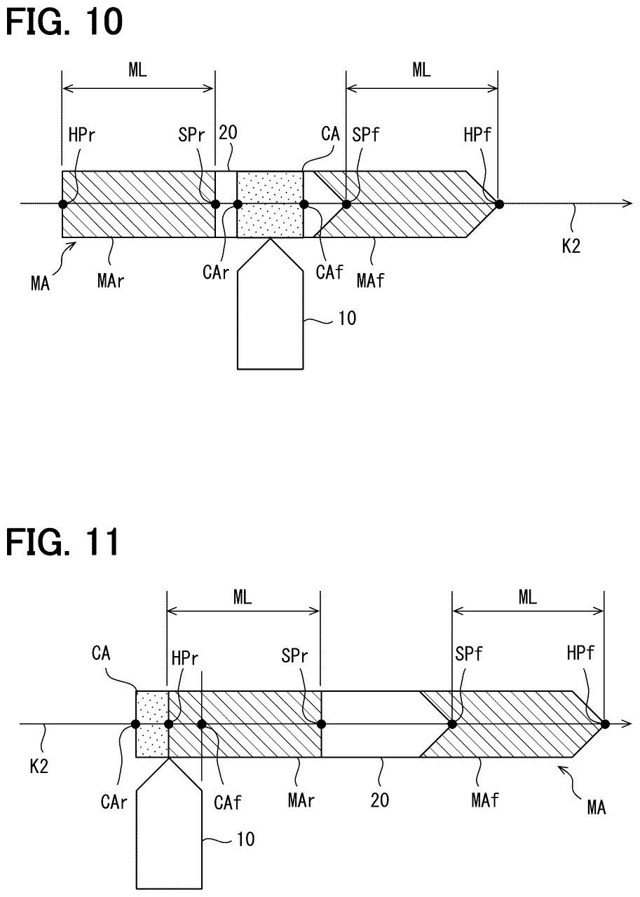

In FIG. 10, the front end determination position HPf is located ahead of the rear end crossing position CAr, and the rear end determination position HPr is located behind the front end crossing position CAf. More specifically, the crossing mobile object 20 is located within the crossing area CA at the arrival time. In other words, the front end crossing position CAf and the rear end crossing position CAr are located between the front end passing-through position SPf and the rear end passing-through position SPr. This state can be said to be a state in which there is a possibility of a collision between the subject vehicle 10 and the crossing mobile object 20, and a sufficient distance is not secured for the crossing situation.

In FIG. 11, the front end determination position HPf is located ahead of the rear end crossing position CAr, and the rear end determination position HPr is located behind the front end crossing position CAf. More specifically, the rear end determination position HPr is located within the crossing area CA. In other words, a part of the post-passing-through margin area MAr overlaps with the crossing area CA. In this state, there is a possibility that the subject vehicle 10 will pass behind the crossing mobile object 20 at close range and cross, and it can be said that there is not sufficient distance for the crossing.

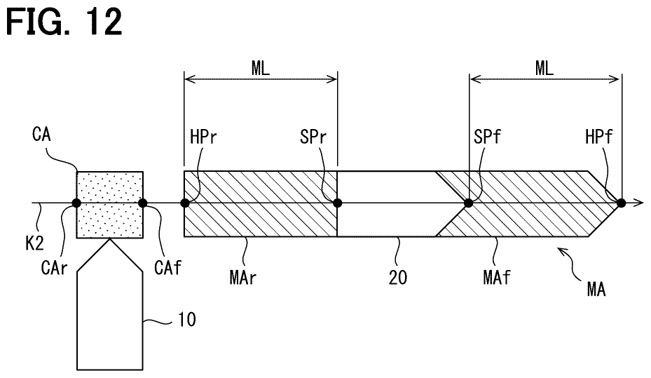

In FIG. 12, the rear end determination position HPr is located ahead of the front end crossing position CAf. In other words, both the front end determination position HPf and the rear end determination position HPr are located outside the crossing area CA. In other words, neither the pre-passing-through margin area MAf nor the post-passing-through margin area MAr overlaps with the crossing area CA. This state can be said to be a state in which a sufficient distance is secured at the crossing situation where the subject vehicle 10 passes behind the crossing mobile object 20.

In step S151 of FIG. 4, the drive support control unit 75 executes the drive support. More specifically, the brake support is executed to reduce the vehicle speed and delay the arrival time. As a result, the rear end determination position HPr is located ahead of the front end crossing position CAf. Alternatively, by providing the steering support, a state can be created in which a larger distance can be maintained between the subject vehicle and the crossing mobile object 20 at the crossing situation with the crossing mobile object 20. Alternatively, by providing the collision warning support, the driver is prompted to execute a driving operation so as to maintain a large distance from the crossing mobile object 20 at the crossing situation with the crossing mobile object 20. If there are multiple crossing mobile objects 20 that are determined to require for the subject vehicle to execute the drive support, the priority is given to executing the drive support to the crossing mobile object 20 whose crossing area CA is set at a position closest to the subject vehicle 10. After the drive support is executed, the process proceeds to step S171.

In step S161, the drive support control unit 75 stops the drive support. More specifically, if the drive support is already being executed, the drive support being executed is stopped. n the other hand, if the drive support is not currently being executed, the drive support is stopped by maintaining the state in which the drive support is not being executed. After the drive support is stopped, the process proceeds to step S171.

In step S171, the determination unit 74 determines whether the subject vehicle 10 has finished traveling. For example, if the shift lever of the subject vehicle 10 is in the parking position, it can be determined that the subject vehicle 10 has stopped traveling. If it is determined that the subject vehicle has finished traveling, the crossing support control is terminated. On the other hand, if it is determined that the subject vehicle has not yet finished traveling, the process returns to step S101 and repeats the series of the crossing support control. This allows the execution of the drive support to be switched according to the surrounding conditions, which change over time. For example, it is assumed that, by executing the drive support, the subject vehicle trajectory K1 and the object trajectory K2 will no longer cross each other, or the rear end determination position HPr will be located ahead of the front end crossing position CAf. In this case, by repeating a series of the crossing support control, it is possible to quickly stop the drive support that is no longer needed.

The following will describe technical effects of the present embodiment. According to the above-described embodiment, the determination unit 74 determines that the drive support is required when the front end determination position HPf is located ahead of the rear end crossing position CAr in the direction of travel of the crossing mobile object 20, and when the rear end determination position HPr is located behind the front end crossing position CAf in the direction of travel of the crossing mobile object 20. Therefore, the drive support can be provided in a crossing situation at a close distance where a crossing area CA is disposed between the front end determination position HPf and the rear end determination position HPr. Therefore, it is easy to ensure a sufficient distance between the subject vehicle 10 and the crossing mobile object 20, thereby improving safety in the crossing situation. Thus, the embodiments provides a drive support system 100 that can improve safety in a crossing situation.

The determination unit 74 also determines whether or not to execute the drive support based on the determined position acquired by adding the margin distance ML to the passing-through position. Therefore, the drive support is more likely to be executed than when the margin distance ML is not taken into consideration and the need for the drive support is determined only by predicting whether or not the subject vehicle 10 will collide with the crossing mobile object 20. In other words, it is easier to prevent the system from determining that the drive support is not necessary even when the situation actually requires the drive support. Here, the arrival time changes as the subject vehicle speed changes, and accordingly the position of the crossing mobile object 20 at the time when the arrival time has elapsed also changes. At this time, the larger the speed of the crossing mobile object 20, the larger the change in the position of the crossing mobile object 20 at the time point when the arrival time has elapsed. In other words, the larger the speed of the crossing mobile object 20, the more difficult it is to accurately predict the position of the crossing mobile object 20 at the time when the arrival time has elapsed, and the more difficult it is to accurately determine whether the drive support is necessary. Therefore, making it easier to execute the drive support by determining whether or not the drive support is necessary by taking the margin distance ML into consideration is particularly useful when the object speed of the crossing mobile object 20 is high.

The margin distance setting unit 73 sets the margin distance ML to a larger value as the speed of the subject vehicle 10 increases. Here, the higher the subject vehicle speed, the more likely it is that the accuracy of predicting the passing-through position will decrease. Therefore, even if the passing-through position changes significantly due to a change in the subject vehicle speed, safe crossing can be achieved.

The margin distance setting unit 73 sets the margin distance ML to a larger value as the object speed, which is the speed of the crossing mobile object 20, increases. Here, the higher the object speed, the more likely it is that the accuracy of predicting the passing-through position will decrease. For example, assume that the arrival time changes by one second. In this case, if the object speed is 60 km/h, the passing-through position will change by 16.7 m. On the other hand, when the object speed is 120 km/h, the passing-through position will change by 33.3 m. Therefore, even if the passing-through position changes significantly due to a change in the arrival time or object speed, safe crossing can be easily achieved.

The margin distance setting unit 73 sets the margin distance ML to a larger value as the object movement distance increases. In other words, the margin distance setting unit 73 sets the margin distance ML to a larger value as the crossing mobile object 20 is farther away from the subject vehicle 10. Here, the larger the object movement distance, the more likely the prediction accuracy is to decrease. Therefore, even if the passing-through position changes significantly, it is easy to achieve a safe crossing.

If the determination unit 74 determines that the drive support is not necessary while the drive support is being executed, the drive support control unit 75 stops the drive support being executed. For example, if the subject vehicle trajectory K1 and the object trajectory K2 no longer cross each other while the drive support is being executed, the drive support being executed is stopped. Therefore, even if the drive support is being executed, if the drive support becomes unnecessary, the drive support can be quickly stopped to prevent unnecessary operation of the drive support.

When the crossing mobile object 20 passes through the crossing area CA, the determination unit 74 determines that the drive support is not necessary even if the front end determination position HPf is located ahead of the rear end crossing position CAr in the direction of travel of the crossing mobile object 20 and the rear end determination position HPr is located behind the front end crossing position CAf in the direction of travel of the crossing mobile object 20. This is because the subject vehicle trajectory K1 and the object trajectory K2 no longer cross each other as the crossing mobile object 20 passes through the crossing area CA. Therefore, even if the drive support is being executed, it can be stopped when the drive support is no longer necessary. Therefore, unnecessary operation of the drive support can be suppressed.

### Second Embodiment

The present embodiment is a modification of the above-described embodiments. In this embodiment, the front end determination position HPf and the rear end determination position HPr are set using a pre-passing-through margin distance MLf and a post-passing-through margin distance MLr, which are different from each other.

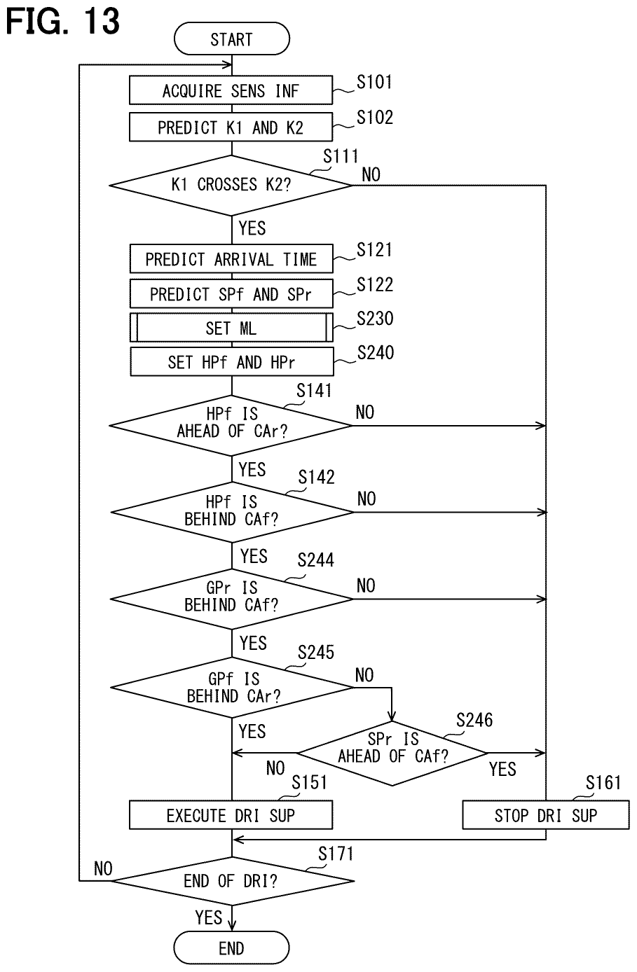

In FIG. 13, after the front end passing-through position SPf and the rear end passing-through position SPr are predicted in step S122, the process proceeds to step S230, where the margin distance setting unit 73 sets the margin distance ML. The margin distance setting process in this embodiment will be described below with reference to the drawings.

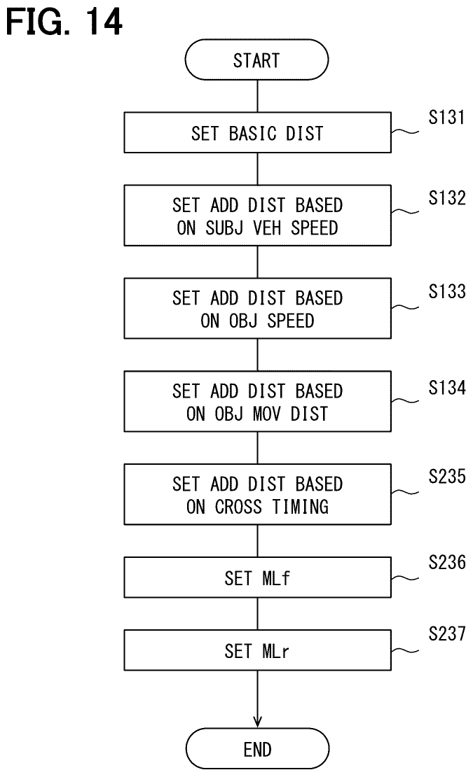

In FIG. 14, when the margin distance setting process is started, a basic distance is set in step S131, and the process proceeds to step S132. In step S132, an additional distance based on the subject vehicle speed is set, and the process proceeds to step S133. In step S133, an additional distance based on the object speed is set, and the process proceeds to step S134. In step S134, an additional distance is set based on the object movement distance, and the process proceeds to step S235.

In step S235, the margin distance setting unit 73 sets an additional distance based on the crossing timing. Here, the crossing timing is information indicating whether the crossing mobile object 20 has already passed through the crossing area CA at the time when the arrival time has elapsed. More specifically, this information indicates whether the rear end passing-through position SPr is located ahead of the front end crossing position CAf. When the rear end passing-through position SPr is located ahead of the front end crossing position CAf, it can be determined that the crossing mobile object 20 has already passed through the crossing area CA when the arrival time has elapsed. On the other hand, if the rear end passing-through position SPr is located behind the front end crossing position CAf, it can be determined that the crossing mobile object 20 has not yet passed through the crossing area CA when the arrival time has elapsed.

If the crossing mobile object 20 has already passed through the crossing area CA when the arrival time has elapsed, the subject vehicle 10 will arrive at the crossing area CA after the crossing mobile object 20 has passed. In this case, the crossing occurs after passing through. On the other hand, if the crossing mobile object 20 has not passed through the crossing area CA when the arrival time has elapsed, the subject vehicle 10 will arrive at the crossing area CA before the crossing mobile object 20 passes through. In this case, the crossing occurs before passing through.

In the case of crossing after passing through, the crossing mobile object 20 crosses ahead of the subject vehicle 10. Therefore, it can be said that this is a situation in which the subject vehicle 10 is expected to wait for the crossing mobile object 20 to pass through. In this case, the subject vehicle 10 needs to prepare for the possibility that the speed of the crossing mobile object 20 may become slower than predicted speed due to an unexpected deceleration of the crossing mobile object 20, for example.

In the case of crossing before passing through, the subject vehicle 10 crosses ahead of the crossing mobile object 20. Therefore, it can be said that this is a situation in which the crossing mobile object 20 is expected to wait for the subject vehicle 10 to pass through. In this case, the subject vehicle 10 needs to prepare for the possibility that the speed of the crossing mobile object 20 may become faster than predicted speed due to unexpected acceleration of the crossing mobile object 20, for example.

If the crossing before passing through is predicted, it is possible that the crossing mobile object 20 may accelerate unexpectedly, making it impossible to maintain a sufficient distance between the subject vehicle 10 and the crossing mobile object 20 at the time of arrival. In this case, it is necessary to decelerate the subject vehicle 10 so that the crossing timing switches from the crossing before passing through to the crossing after passing through. For this reason, in the case of the crossing before passing through, the additional distance is set in advance to be larger than that of the crossing after passing through so as to be able to cope with switching from the crossing before passing through to the crossing after passing through. The additional distance set in preparation for switching from the crossing before passing through to the crossing after passing through is the additional distance based on the crossing timing. After setting the additional distance based on the crossing timing, the process proceeds to step S236.

In step S236, a pre-passing-through margin distance MLf is set. The pre-passing-through margin distance MLf is the margin distance ML required in the same direction as the traveling direction of the crossing mobile object 20. The pre-passing-through margin distance MLf is set by adding together an additional distance based on the subject vehicle speed, an additional distance based on the object speed, an additional distance based on the object movement distance, and an additional distance based on the crossing timing. After the pre-passing-through margin distance MLf is set, the process proceeds to step S237.

In step S237, a post-passing-through margin distance MLr is set. The post-passing-through margin distance MLr is the margin distance ML required in the direction opposite to the traveling direction of the crossing mobile object 20. The post-passing-through margin distance MLr is set by adding together an additional distance based on the subject vehicle speed, an additional distance based on the object speed, and an additional distance based on the target movement distance. In other words, the additional distance based on the crossing timing is not added together and the additional distance is set. Therefore, the post-passing-through margin distance MLr is set to a value smaller than the pre-passing-through margin distance MLf. After setting the post-passing-through margin distance MLr, the process proceeds to step S240.

In step S240 of FIG. 13, the determination position setting unit 76 sets the front end determination position HPf and the rear end determination position HPr. The front end determination position HPf is a position acquired by adding the pre-passing-through margin distance MLf in the positive direction to the front end passing-through position SPf. In other words, the front end determination position HPf is a position displaced ahead of the front end passing-through position SPf as a starting point along the object trajectory K2 by the pre-passing-through margin distance MLf.

The rear end determination position HPr is a position acquired by adding a post-passing-through margin distance MLr in the negative direction to the rear end passing-through position SPr. In other words, the rear end determination position HPr is a position that is displaced behind along the object trajectory K2 by the post-passing-through margin distance MLr from the rear end passing-through position SPr as a starting point. Since the pre-passing-through margin distance MLf is larger than the post-passing-through margin distance MLr, the front end determination position HPf is set at a position farther away from the subject vehicle 10 than the rear end determination position HPr. After the front end determination position HPf and the rear end determination position HPr are set, the process proceeds to step S141.

In step S141, the determination unit 74 determines whether the front end determination position HPf is located ahead of the rear end crossing position CAr in the traveling direction of the crossing mobile object 20. Since the front end determination position HPf also takes into account the additional distance based on the crossing timing, it is more likely to be determined to be located ahead of the rear end crossing position CAr than when the additional distance based on the crossing timing is not taken into account. If it is determined that the front end determination position HPf is located ahead of the rear end crossing position CAr in the traveling direction of the crossing mobile object 20, the process proceeds to step S142.

In step S142, the determination unit 74 determines whether the rear end determination position HPr is located behind the front end crossing position CAf in the traveling direction of the crossing mobile object 20. If the rear end determination position HPr is located behind the front end crossing position CAf, it is determined that there is a possibility that sufficient distance cannot be secured for the crossing situation between the subject vehicle 10 and the crossing mobile object 20, and the process proceeds to step S244.

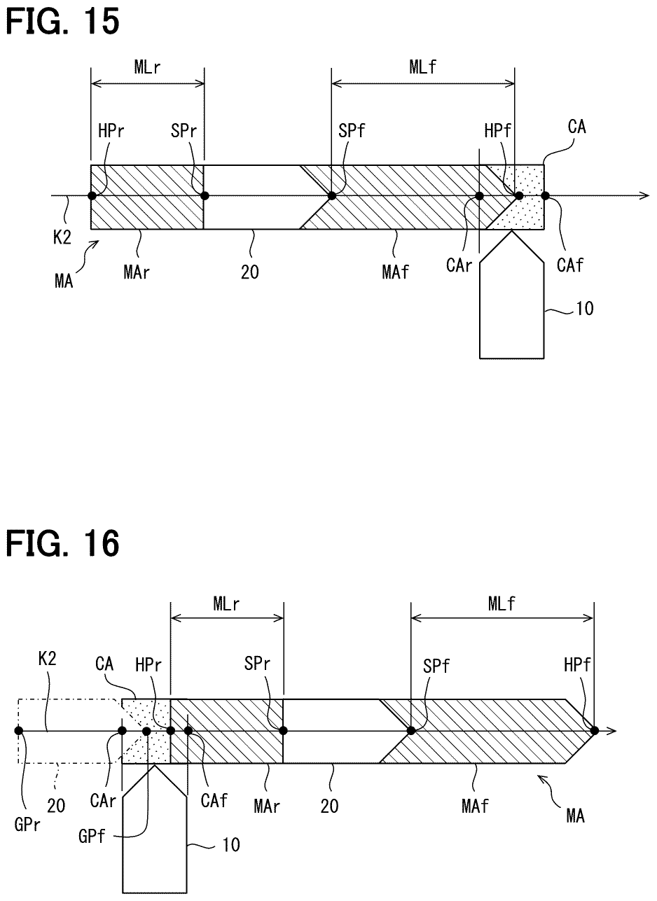

In FIG. 15, the pre-passing-through margin distance MLf is larger than the post-passing-through margin distance MLr. Therefore, the area of the pre-passing-through margin area MAf is larger than the area of the post-passing-through margin area MAr. In the drawing, a part of the pre-passing-through margin area MAf overlaps with the crossing area CA. In this state, there is a possibility that the subject vehicle 10 will pass ahead of the crossing mobile object 20 at close range and cross, and it can be said that there is not sufficient distance for the crossing.

In step S244 of FIG. 13, the determination unit 74 determines whether the rear end current position GPr is located behind the front end crossing position CAf in the traveling direction of the crossing mobile object 20. This determination can also be said to be a determination as to whether or not the current position of the crossing mobile object 20 has already passed through the crossing area CA. If the rear end current position GPr is ahead of the front end crossing position CAf, it is determined that the crossing mobile object 20 has already passed through the crossing area CA and there is no possibility of a collision, and the process proceeds to step S161. On the other hand, if the rear end current position GPr is behind the front end crossing position CAf, it is determined that the crossing mobile object 20 has not yet passed through the crossing area CA, and the process proceeds to step S245.

In step S245, the determination unit 74 determines whether the front end current position GPf is located behind the rear end crossing position CAr in the traveling direction of the crossing mobile object 20. This determination can also be said to be a determination as to whether the current position of the crossing mobile object 20 is before entering the crossing area CA. If the front end current position GPf is located behind the rear end crossing position CAr in the traveling direction of the crossing mobile object 20, the process proceeds to step S151. On the other hand, if the front end current position GPf is located ahead of the rear end crossing position CAr in the traveling direction of the crossing mobile object 20, the process proceeds to step S246.

In step S246, the determination unit 74 determines whether the rear end passing-through position SPr is located ahead of the front end crossing position CAf in the traveling direction of the crossing mobile object 20. In other words, it can be said that it is determined whether the position of the crossing mobile object 20 is disposed outside the crossing area CA at the time when the arrival time has elapsed. The rear end passing-through position SPr is located ahead of the rear end determination position HPr. Therefore, the rear end passing-through position SPr is more likely to be located ahead of the front end crossing position CAf than the rear end determination position HPr.

In FIG. 16, the crossing mobile object 20 at its current position is indicated by a dashed line, and the crossing mobile object 20 at the time when the arrival time has elapsed is indicated by a solid line. In this drawing, at least the front end of the crossing mobile object 20 at the current position is located between the rear end crossing position CAr and the front end crossing position CAf. That is, the current position of the crossing mobile object 20 is within the crossing area CA. Furthermore, the rear end passing-through position SPr is located ahead of the front end crossing position CAf in the traveling direction of the crossing mobile object 20. In the state shown in this drawing, a situation will come when the subject vehicle trajectory K1 and the object trajectory K2 no longer cross each other between the current time and the arrival time.

In step S246 of FIG. 13, if the rear end passing-through position SPr is located behind the front end crossing position CAf in the direction of travel of the crossing mobile object 20, it is determined that the drive support is necessary, and the process proceeds to step S151, where the drive support is executed. On the other hand, if the rear end passing-through position SPr is located ahead of the front end crossing position CAf in the direction of travel of the crossing mobile object 20, it is determined that the drive support is not necessary, and the process proceeds to step S161, where the drive support is stopped. This is because, after the arrival time has elapsed, it can be determined that there will be no contact between the subject vehicle 10 and the crossing mobile object 20, and therefore no drive support regarding the crossing situation is necessary.

The following will describe technical effects of the present embodiment. According to the embodiment described above, the determination position setting unit 76 sets the position acquired by adding the pre-passing-through margin distance MLf in the traveling direction of the crossing mobile object 20 to the front end passing-through position SPf as the front end determination position HPf. Furthermore, the determination position setting unit 76 sets the position acquired by adding a post-passing-through margin distance MLr in the direction opposite to the traveling direction of the crossing mobile object 20 to the rear end passing-through position SPr as the rear end determination position HPr. Therefore, it is possible to individually set a pre-passing-through margin distance MLf, which is the margin distance ML for coping with the crossing before passing-through, and a post-passing-through margin distance MLr, which is the margin distance ML for coping with a crossing after passing-through. Therefore, the front end determination position HPf and the rear end determination position HPr can be properly set in accordance with different crossing situations, i.e., the crossing before passing through and the crossing after passing through. Therefore, it is easy to provide proper drive support in response to different crossing situations, such as the crossing before passing through and the crossing after passing through.

The margin distance setting unit 73 sets the pre-passing-through margin distance MLf to be larger than the post-passing-through margin distance MLr. Therefore, it is easy to respond to switching from the crossing before passing through to the crossing after passing through due to reasons such as acceleration of the crossing mobile object 20. Therefore, it is easy to provide proper drive support in response to various crossing situations.

The determination unit 74 determines that the drive support is not necessary when the rear end current position GPr is located ahead of the front end crossing position CAf. In other words, the determination unit 74 determines that the drive support is not necessary when the current position of the crossing mobile object 20 is a position that has passed through the crossing area CA. Therefore, when the crossing mobile object 20 has passed through the crossing area CA and there is no longer any possibility of a collision between the crossing mobile object 20 and the subject vehicle 10, it can be determined that the drive support is no longer necessary. Therefore, unnecessary operation of the drive support can be suppressed.

The determination unit 74 determines that the drive support is not necessary when the rear end current position GPr is located behind the front end crossing position CAf, the front end current position GPf is located ahead of the rear end crossing position CAr, and the rear end passing-through position SPr is located ahead of the front end crossing position CAf. In other words, when the current position of the crossing mobile object 20 is within the crossing area CA and it is predicted that there will be no collision between the crossing mobile object 20 and the subject vehicle 10 at the arrival time, it can be determined that the drive support is not necessary. Therefore, even if the drive support is being executed, the drive support can be stopped when it becomes unnecessary, thereby preventing unnecessary operation of the drive support. Furthermore, if it is determined that the drive support is not necessary before the crossing mobile object 20 enters the crossing area CA because the rear end passing-through position SPr is located ahead of the front end crossing position CAf, the determination result of the collision prediction is likely to change due to changes in the speed of the crossing mobile object 20 or the subject vehicle 10. On the other hand, if the crossing mobile object 20 is within the crossing area CA, the time required for the crossing mobile object 20 to pass through the crossing area CA is short, and the determination result of the collision prediction is unlikely to change. Therefore, it is easy to properly determine that the drive support is not necessary and to suppress unnecessary operation of the drive support.

The determination of steps S141 and S142 corresponds to determining whether the crossing area line segment and the determination position line segment overlap in a one-dimensional coordinate system along the object trajectory K2. Here, the crossing area line segment is a line segment that has the rear end crossing position CAr as its start point and the front end crossing position CAf as its end point. The determination position line segment is a line segment whose starting point is the rear end determination position HPr and whose ending point is the front end determination position HPf. If the determination results in both steps S141 and S142 are “YES”, this feature corresponds to the case where the crossing area line segment and the determination position line segment overlap each other. If the determination result in either step S141 or step S142 is “NO”, this feature corresponds to a case where the crossing area line segment and the determination position line segment do not overlap. The size of the determination position line segment is the sum of the length of the crossing mobile object 20 in the direction along the object trajectory K2, the pre-passing-through margin distance MLf, and the post-passing-through margin distance MLr. Therefore, the larger the length of the crossing mobile object 20 in the direction along the object trajectory K2, the larger the size of the determination position line segment. Therefore, it can be said that the length of the crossing mobile object 20 affects the determination of whether the drive support is necessary in the crossing support control.

### Other Embodiments

The disclosure in the present disclosure and drawings is not limited to the exemplified embodiments. The present disclosure includes embodiments described above and modifications of the above-described embodiments made by a person skilled in the art. For example, the disclosure is not limited to components and/or combinations of elements presented in the embodiments provided herein. The present disclosure may be implemented in various combinations thereof. The disclosure may have additional components that can be added to the embodiments. The present disclosure also includes modifications which include partial components/elements of the above-described embodiments. The present disclosure also includes replacement or combination of components and/or elements between one embodiment and another. The disclosed technical scope is not limited to the description of the embodiments. It should be understood that some disclosed technical ranges are indicated by description of embodiments, and includes every modification within the equivalent meaning and the scope of description of embodiments.

The disclosure in the specification, drawings and the like is not limited by the description of the embodiments. The disclosures in the specification, the drawings, and the like include the technical ideas described in the embodiments, and further extend to a wider variety of technical ideas than those described in the embodiments. Therefore, various technical ideas can be extracted from the disclosure of the specification, the drawings and the like without being limited to the description of the embodiments.

The image generation unit and method thereof according to the present disclosure may be implemented by one or more special-purposed computers. Such a special-purposed computer may be provided (i) by configuring (a) a processor and a memory programmed to execute one or more functions embodied by a computer program, or (ii) by configuring (b) a processor including one or more dedicated hardware logic circuits, Alternatively, the device and the method described in the present disclosure may be implemented by a dedicated hardware logic circuit. Alternatively, the device and the method described in the present disclosure may be implemented by one or more dedicated computers configured by a combination of a processor executing a computer program and one or more hardware logic circuits. The computer program may also be stored on a computer-readable and non-transitory tangible storage medium as an instruction executed by a computer.

This specification discloses multiple technical features described in multiple items listed below. Some features may be described in a multiple dependent form, in which subsequent features alternatively refer to preceding features. Some features may be described in a multiple dependent form referring to another multiple dependent form. These features described in a multiple dependent form define multiple technical features.

### Technical Feature 1

A drive support system includes: a detection device (51) that detects a surrounding object; a subject vehicle trajectory prediction unit (72A) that predicts a subject vehicle trajectory (K1) which is a movement trajectory of a subject vehicle (10); an object trajectory prediction unit (72B) that predicts an object trajectory (K2) which is a movement trajectory of a crossing mobile object (20) detected by the detection device; a time prediction unit (72C) that predicts an arrival time which is a time required for the subject vehicle to arrive at a crossing area (CA) where the subject vehicle trajectory and the object trajectory cross each other; a position prediction unit (72D) that predicts a front end passing-through position (SPf) which is a position of a front end of the crossing mobile object at a time when the arrival time has elapsed, and a rear end passing-through position (SPr) which is a position of a rear end of the crossing mobile object at the time when the arrival time has elapsed; a margin distance setting unit (73) that sets a margin distance (ML) required between the subject vehicle and the crossing mobile object at the time when the arrival time has elapsed; a determination position setting unit (76) that sets a front end determination position (HPf) which is a position calculated by adding the margin distance to the front end passing-through position in a travelling direction of the crossing mobile object, and a rear end determination position (HPr) which is a position calculated by adding the margin distance to the rear end passing-through position of in a direction opposite to the travelling direction of the crossing mobile object, and that sets a front end crossing position (CAf) which is an end position located ahead of the crossing mobile object in the travelling direction of the crossing mobile object in an crossing area, and a rear end crossing position (CAr) which is an end position located behind the crossing mobile object in the travelling direction of the crossing mobile object in the crossing area; a determination unit (74) that determines that a drive support is not necessary when the front end determination position is located behind the rear end crossing position in the traveling direction of the crossing mobile object, or when the rear end determination position is located ahead of the front end crossing position in the traveling direction of the crossing mobile object, and determines that the drive support is necessary when the front end determination position is located ahead of the rear end crossing position in the traveling direction of the crossing mobile object, and the rear end determination position is located behind the front end crossing position in the traveling direction of the crossing mobile object; and a drive support control unit (75) that provides the drive support using a drive support device (80) when the determination unit determines that the drive support is necessary, and stops the drive support when the determination unit determines that the drive support is not necessary.

### Technical Feature 2

In the drive support system according to technical feature 1, the margin distance setting unit sets the margin distance to a larger value as a speed of the subject vehicle increases.

### Technical Feature 3

In the drive support system according to technical feature 2, the margin distance setting unit sets the margin distance to a larger value as an object speed, which is a speed of the crossing mobile object, increases.

### Technical Feature 4

In the drive support system according to any one of technical features 1 to 3, the margin distance setting unit sets the margin distance to a larger value as a position of the crossing mobile object becomes farther from the subject vehicle.

### Technical Feature 5

In the drive support system according to any one of technical features 1 to 4, the margin distance setting unit sets a pre-passing-through margin distance (MLf) which is the margin distance when a position of the crossing mobile object at the time when the arrival time has elapsed is a position before the crossing mobile object passes through the crossing area, and a post-passing-through margin distance (MLr) which is the margin distance when the position of the crossing mobile object at the time when the arrival time has elapsed is a position after the crossing mobile object has passed through the crossing area. The determination position setting unit sets a position acquired by adding the front end passing-through position and the pre-passing-through margin distance in the travelling direction of the crossing mobile object as the front end determination position, and sets a position acquired by adding the rear end passing-through position and the post-passing-through margin distance in the direction opposite to the travelling direction of the crossing mobile object as the rear end determination position.

### Technical Feature 6

In the drive support system according to technical feature 5, the margin distance setting unit sets the pre-passing-through margin distance to be larger than the post-passing-through margin distance.

### Technical Feature 7

In the drive support system according to any one of technical features 1 to 6, the drive support control unit stops the drive support being executed when the determination unit determines that the drive support is not necessary while the drive support is being executed.

### Technical Feature 8

In the drive support system according to technical feature 7, the determination unit determines that the drive support is not necessary when a rear end current position (GPr), which is a rear end position of the crossing mobile object at a current time, is located ahead of the front end crossing position in the travelling direction of the crossing mobile object, even when the front end determination position is located ahead of the rear end crossing position in the travelling direction of the crossing mobile object and the rear end determination position is located behind the front end crossing position in the travelling direction of the crossing mobile object.

### Technical Feature 9

In the drive support system according to technical feature 8, the determination unit determines that the drive support is not necessary when the rear end current position is located behind the front end crossing position in the travelling direction of the crossing mobile object, the front end current position (GPf), which is a front end position of the crossing mobile object at the current time, is located ahead of the rear end crossing position in the travelling direction of the crossing mobile object, and the rear end passing-through position is located ahead of the front end crossing position in the travelling direction of the crossing mobile object, even when the front end determination position is located ahead of the rear end crossing position in the travelling direction of the crossing mobile object and the rear end determination position is located behind the front end crossing position in the travelling direction of the crossing mobile object.

Reference number 10 indicates a vehicle, reference number 20 indicates a crossing mobile object, reference number 51 indicates a detection device, reference number 52 indicates a steering angle sensor, reference number 53 indicates a yaw rate sensor, reference number 54 indicates a wheel speed sensor, reference number 70 indicates a control unit, reference number 71 indicates an acquisition unit, reference number 72 indicates a prediction unit, reference number 72A indicates a vehicle trajectory prediction unit, reference number 72B indicates an object trajectory prediction unit, reference number 72C indicates a time prediction unit, reference number 72D indicates a position prediction unit, reference number 73 indicates a margin distance setting unit, reference number 74 indicates a determination unit, reference number 75 indicates a drive support control unit, reference number 76 indicates a determination position setting unit, reference number 80 indicates a drive support device, reference number 100 indicates a drive support system, reference symbol CA indicates a crossing area, reference symbol CAf indicates a front end crossing position, reference symbol CAr indicates a rear end crossing position, reference symbol GPf indicates a front end current position, reference symbol GPr indicates a rear end current position, reference symbol HPf indicates a front end determination position, reference symbol HPr indicates a rear end determination position, reference symbol K1 indicates a subject vehicle trajectory, reference symbol K2 indicates an object trajectory, reference symbol MA indicates a margin area, reference symbol MAf indicates a pre-passing-through margin area, reference symbol MAr indicates a post-passing-through margin area, reference symbol ML indicates a margin distance, reference symbol MLf indicates a pre-passing-through margin distance, reference symbol MLr indicates a post-passing-through margin distance, reference symbol SPf indicates a front end passing-through position, and reference symbol SPr indicates a rear end passing-through position.

It is noted that a flowchart or the processing of the flowchart in the present application includes sections (also referred to as steps), each of which is represented, for instance, as S101. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A drive support system comprising:
at least one of (i) a circuit and (ii) a processor with a memory storing computer program code executable by the processor, wherein:
the at least one of the circuit and the processor is configured to cause the drive support system device to execute:
detecting a surrounding object;
predicting a subject vehicle trajectory which is a movement trajectory of a subject vehicle;
predicting an object trajectory which is a movement trajectory of a crossing mobile object detected in the detecting of the surrounding object;
predicting an arrival time which is a time required for the subject vehicle to arrive at a crossing area where the subject vehicle trajectory and the object trajectory cross each other;
predicting a front end passing-through position which is a position of a front end of the crossing mobile object at a time when the arrival time has elapsed, and a rear end passing-through position which is a position of a rear end of the crossing mobile object at the time when the arrival time has elapsed;
setting a margin distance required between the subject vehicle and the crossing mobile object at the time when the arrival time has elapsed;
setting a front end determination position which is a position calculated by adding the margin distance to the front end passing-through position in a travelling direction of the crossing mobile object, and a rear end determination position which is a position calculated by adding the margin distance to the rear end passing-through position of in a direction opposite to the travelling direction of the crossing mobile object,
setting a front end crossing position which is an end position located ahead of the crossing mobile object in the travelling direction of the crossing mobile object in an crossing area, and a rear end crossing position which is an end position located behind the crossing mobile object in the travelling direction of the crossing mobile object in the crossing area;
determining that a drive support is not necessary when the front end determination position is located behind the rear end crossing position in the traveling direction of the crossing mobile object, or when the rear end determination position is located ahead of the front end crossing position in the traveling direction of the crossing mobile object;
determining that the drive support is necessary when the front end determination position is located ahead of the rear end crossing position in the traveling direction of the crossing mobile object, and the rear end determination position is located behind the front end crossing position in the traveling direction of the crossing mobile object;
providing the drive support using a drive support device when it is determined in the determining that the drive support is necessary; and
stopping the drive support when it is determined in the determining that the drive support is not necessary.

2. The drive support system according to claim 1, wherein:
the at least one of the circuit and the processor is configured to cause the drive support system device to further execute: setting the margin distance to a larger value as a speed of the subject vehicle increases.

3. The drive support system according to claim 1, wherein:
the at least one of the circuit and the processor is configured to cause the drive support system device to further execute: setting the margin distance to a larger value as an object speed, which is a speed of the crossing mobile object, increases.

4. The drive support system according to claim 1, wherein:
the at least one of the circuit and the processor is configured to cause the drive support system device to further execute: setting the margin distance to a larger value as a position of the crossing mobile object becomes farther from the subject vehicle.

5. The drive support system according to claim 1, wherein:
the at least one of the circuit and the processor is configured to cause the drive support system device to further execute:
setting a pre-passing-through margin distance which is the margin distance when a position of the crossing mobile object at the time when the arrival time has elapsed is a position before the crossing mobile object passes through the crossing area;
setting a post-passing-through margin distance which is the margin distance when the position of the crossing mobile object at the time when the arrival time has elapsed is a position after the crossing mobile object has passed through the crossing area;
setting a position acquired by adding the front end passing-through position and the pre-passing-through margin distance in the travelling direction of the crossing mobile object as the front end determination position; and
setting a position acquired by adding the rear end passing-through position and the post-passing-through margin distance in the direction opposite to the travelling direction of the crossing mobile object as the rear end determination position.

6. The drive support system according to claim 5, wherein:
the at least one of the circuit and the processor is configured to cause the drive support system device to further execute: setting the pre-passing-through margin distance to be larger than the post-passing-through margin distance.

7. The drive support system according to claim 1, wherein:
the at least one of the circuit and the processor is configured to cause the drive support system device to further execute: stopping the drive support being executed when it is determined in the determining that the drive support is not necessary while the drive support is being executed.

8. The drive support system according to claim 7, wherein:
the at least one of the circuit and the processor is configured to cause the drive support system device to further execute: determining that the drive support is not necessary when a rear end current position, which is a rear end position of the crossing mobile object at a current time, is located ahead of the front end crossing position in the travelling direction of the crossing mobile object, even when the front end determination position is located ahead of the rear end crossing position in the travelling direction of the crossing mobile object and the rear end determination position is located behind the front end crossing position in the travelling direction of the crossing mobile object.

9. The drive support system according to claim 8, wherein:
the at least one of the circuit and the processor is configured to cause the drive support system device to further execute: determining that the drive support is not necessary when the rear end current position is located behind the front end crossing position in the travelling direction of the crossing mobile object, a front end current position, which is a front end position of the crossing mobile object at the current time, is located ahead of the rear end crossing position in the travelling direction of the crossing mobile object, and the rear end passing-through position is located ahead of the front end crossing position in the travelling direction of the crossing mobile object, even when the front end determination position is located ahead of the rear end crossing position in the travelling direction of the crossing mobile object and the rear end determination position is located behind the front end crossing position in the travelling direction of the crossing mobile object.

10. The drive support system according to claim 1, wherein:
the drive support device provides the drive support which includes at least one of a braking support, a steering support, an acceleration support and a collision warning support;
the brake support is executed to reduce a speed of the subject vehicle and delay the arrival time;
the steering support is executed to create a state in which a larger distance can be maintained between the subject vehicle and the crossing mobile object at a crossing situation with the crossing mobile object;
the acceleration support is executed to increase the speed of the subject vehicle and accelerate the arrival time; and
the collision warning support is executed to prompt a driver of the subject vehicle to execute a driving operation so as to maintain a large distance from the crossing mobile object at the crossing situation with the crossing mobile object.

11. A drive support system comprising:
a detection device that detects a surrounding object;
a subject vehicle trajectory prediction unit that predicts a subject vehicle trajectory which is a movement trajectory of a subject vehicle;
an object trajectory prediction unit that predicts an object trajectory which is a movement trajectory of a crossing mobile object detected by the detection device;
a time prediction unit that predicts an arrival time which is a time required for the subject vehicle to arrive at a crossing area where the subject vehicle trajectory and the object trajectory cross each other;
a position prediction unit that predicts a front end passing-through position which is a position of a front end of the crossing mobile object at a time when the arrival time has elapsed, and a rear end passing-through position which is a position of a rear end of the crossing mobile object at the time when the arrival time has elapsed;
a margin distance setting unit that sets a margin distance required between the subject vehicle and the crossing mobile object at the time when the arrival time has elapsed;
a determination position setting unit that sets a front end determination position which is a position calculated by adding the margin distance to the front end passing-through position in a travelling direction of the crossing mobile object, and a rear end determination position which is a position calculated by adding the margin distance to the rear end passing-through position of in a direction opposite to the travelling direction of the crossing mobile object, and that sets a front end crossing position which is an end position located ahead of the crossing mobile object in the travelling direction of the crossing mobile object in an crossing area, and a rear end crossing position which is an end position located behind the crossing mobile object in the travelling direction of the crossing mobile object in the crossing area;
a determination unit that determines that a drive support is not necessary when the front end determination position is located behind the rear end crossing position in the traveling direction of the crossing mobile object, or when the rear end determination position is located ahead of the front end crossing position in the traveling direction of the crossing mobile object, and determines that the drive support is necessary when the front end determination position is located ahead of the rear end crossing position in the traveling direction of the crossing mobile object, and the rear end determination position is located behind the front end crossing position in the traveling direction of the crossing mobile object; and
a drive support control unit that provides the drive support using a drive support device when the determination unit determines that the drive support is necessary, and stops the drive support when the determination unit determines that the drive support is not necessary.

12. The drive support system according to claim 11, wherein:
the drive support device provides the drive support which includes at least one of a braking support, a steering support, an acceleration support and a collision warning support;
the brake support is executed to reduce a speed of the subject vehicle and delay the arrival time;
the steering support is executed to create a state in which a larger distance can be maintained between the subject vehicle and the crossing mobile object at a crossing situation with the crossing mobile object;
the acceleration support is executed to increase the speed of the subject vehicle and accelerate the arrival time; and
the collision warning support is executed to prompt a driver of the subject vehicle to execute a driving operation so as to maintain a large distance from the crossing mobile object at the crossing situation with the crossing mobile object.

13. A drive support method comprising:
detecting a surrounding object;
predicting a subject vehicle trajectory which is a movement trajectory of a subject vehicle;
predicting an object trajectory which is a movement trajectory of a crossing mobile object detected in the detecting of the surrounding object;
predicting an arrival time which is a time required for the subject vehicle to arrive at a crossing area where the subject vehicle trajectory and the object trajectory cross each other;
predicting a front end passing-through position which is a position of a front end of the crossing mobile object at a time when the arrival time has elapsed, and a rear end passing-through position which is a position of a rear end of the crossing mobile object at the time when the arrival time has elapsed;
setting a margin distance required between the subject vehicle and the crossing mobile object at the time when the arrival time has elapsed;
setting a front end determination position which is a position calculated by adding the margin distance to the front end passing-through position in a travelling direction of the crossing mobile object, and a rear end determination position which is a position calculated by adding the margin distance to the rear end passing-through position of in a direction opposite to the travelling direction of the crossing mobile object;
setting a front end crossing position which is an end position located ahead of the crossing mobile object in the travelling direction of the crossing mobile object in an crossing area, and a rear end crossing position which is an end position located behind the crossing mobile object in the travelling direction of the crossing mobile object in the crossing area;
determining that a drive support is not necessary when the front end determination position is located behind the rear end crossing position in the traveling direction of the crossing mobile object, or when the rear end determination position is located ahead of the front end crossing position in the traveling direction of the crossing mobile object;
determining that the drive support is necessary when the front end determination position is located ahead of the rear end crossing position in the traveling direction of the crossing mobile object, and the rear end determination position is located behind the front end crossing position in the traveling direction of the crossing mobile object;
providing the drive support using a drive support device when it is determined in the determining that the drive support is necessary; and
stopping the drive support when it is determined in the determining that the drive support is not necessary.

14. The drive support method according to claim 13, wherein:
the drive support device provides the drive support which includes at least one of a braking support, a steering support, an acceleration support and a collision warning support;
the brake support is executed to reduce a speed of the subject vehicle and delay the arrival time;
the steering support is executed to create a state in which a larger distance can be maintained between the subject vehicle and the crossing mobile object at a crossing situation with the crossing mobile object;
the acceleration support is executed to increase the speed of the subject vehicle and accelerate the arrival time; and
the collision warning support is executed to prompt a driver of the subject vehicle to execute a driving operation so as to maintain a large distance from the crossing mobile object at the crossing situation with the crossing mobile object.
